(19) United States
(12) Patent Application Publication
(10) Pub. No.: US 2023/0311219 A1
(43) Pub. Date: Oct. 5, 2023

(54) APPARATUS AND METHOD FOR CUTTING HOLE IN GLASS LAMINATE SUBSTRATE

(71) Applicant: CORNING INCORPORATED, CORNING, NY (US)

(72) Inventor: Woo Jin Lee, Cheonan (KR)

(21) Appl. No.: 18/023,908

(22) PCT Filed: Aug. 20, 2021
(86) PCT No.: PCT/US2021/046799

§ 371 Date: Feb. 28, 2023

(30) Foreign Application Priority Data
Sep. 4, 2020 (KR) 10-2020-0113204

(51) Int. Cl. B23B 41/06; C03B 33/07

(52) U.S. Cl. CPC B23B 41/06; C03B 33/07; B23B 2226/45

(57) ABSTRACT

Provided is a hole cutting apparatus for forming a hole in a glass laminate substrate including a substrate, an adhesive layer, and the glass layer which are sequentially stacked. The apparatus includes a rotatable body, and a cutter coupled to a lower portion of the body, configured to form a hole in the glass layer by cutting the glass layer and at least a part of the adhesive layer and to deburr a surface of the hole, and including a cutting portion having a cross-sectional area in a horizontal direction that gradually decreases in a downward direction.

### CROSS-REFERENCE TO RELATED APPLICATION

This application is based on and claims priority under 35 U.S.C. §119 to Korean Patent Application No. 10-2020-0113204, filed on Sep. 4, 2020, in the Korean Intellectual Property Office, the disclosure of which is incorporated by reference herein in its entirety.

### BACKGROUND

### 1. Field

The disclosure relates to an apparatus and method for cutting a hole in a glass laminate substrate, and more particularly, to an apparatus and method for cutting a hole in a glass laminate substrate, which may reduce generation of glass chips or debris and damage to a glass layer.

### 2. Description of Related Art

A glass laminate substrate may have a hole for various purposes such as electrical connection, manufacture of a handle, ventilation, and the like. For example, a hole may be formed in a glass laminate substrate by using a CNC router, water jet, or drilling. There is a demand for a hole cutting apparatus and method which may reduce generation of glass chips or debris and damage to a glass layer when a hole is formed in a glass laminate substrate.

### SUMMARY

Provided is an apparatus and method for cutting a hole in a glass laminate substrate whereby generation of glass chips or debris and damage to a glass layer may be reduced.

Furthermore, provided is an apparatus and method for cutting a hole in a glass laminate substrate, whereby a hole having a smooth inner surface in a glass layer may be formed.

Additional aspects will be set forth in part in the description which follows and, in part, will be apparent from the description, or may be learned by practice of the presented embodiments of the disclosure.

According to an embodiment, a hole cutting apparatus for forming a hole in a glass layer of a glass laminate substrate including a substrate, an adhesive layer, and the glass layer, which are sequentially stacked, includes a rotatable body, and a cutter coupled to a lower portion of the body, configured to form a hole in the glass layer by cutting the glass layer and at least a part of the adhesive layer and to deburr a surface of the hole, and including a cutting portion having a cross-sectional area in a horizontal direction that gradually decreases in a downward direction.

In an embodiment, when viewed from a side thereof, the cutting portion may have an inverted trapezoidal shape, and a side surface of the cutting portion may form an inclined angle with a lower surface of the cutting portion, and the inclined angle is 15° to 75°.

In an embodiment, the side surface of the cutting portion may be a curved surface having an inclination that decreases further toward a center portion of a lower surface of the cutting portion.

In an embodiment, the thickness of the cutting portion of the cutter may be greater than the thickness of the glass layer.

In an embodiment, the thickness of the cutting portion of the cutter may be greater than the sum of the thickness of the glass layer and the thickness of the adhesive layer.

In an embodiment, when the thickness of the glass layer of the glass laminate substrate is 100 micrometers to 150 micrometers, the thickness of the cutting portion of the cutter may exceed 150 micrometers.

In an embodiment, the section of the cutting portion of the cutter may have a circular shape, and the radius of an upper surface of the cutting portion may be greater than the radius of a lower surface of the cutting portion.

In an embodiment, a difference between the radius of the upper surface of the cutting portion and the radius of the lower surface of the cutting portion may be 10 micrometers to 500 micrometers.

In an embodiment, the cutter may include diamond.

According to another embodiment, a hole cutting apparatus for forming a hole in a glass layer of a glass laminate substrate in which a substrate, an adhesive layer, and the glass layer are sequentially stacked, the hole cutting apparatus including a rotatable body, and a cutter coupled to a lower portion of the body, configured to cut the glass layer and at least a part of the adhesive layer, and including a cutting portion having a cross-sectional area in a horizontal direction that gradually decreases in a downward direction and a connection portion connecting the cutting portion and the body.

In an embodiment, roughness of a surface of the cutting portion of the cutter may be less than roughness of a surface of the connection portion of the cutter.

In an embodiment, when viewed from a side thereof, the cutting portion may have an inverted trapezoidal shape or a semicircular shape, and the connection portion may have a rectangular shape.

In an embodiment, the thickness of the cutting portion may be greater than the thickness of the glass layer.

In an embodiment, a section of the cutting portion of the cutter may have a circular shape, and the radius of an upper surface of the cutting portion may be greater than the radius of a lower surface of the cutting portion, and a difference between the radius of the upper surface of the cutting portion and the radius of the lower surface of the cutting portion may be 10 micrometers to 500 micrometers.

According to another embodiment, a hole cutting method of forming a hole in a glass layer of a glass laminate substrate in which a substrate, an adhesive layer, and the glass layer are sequentially stacked, the hole cutting method including forming a tapered hole in the glass layer, a circumference of a top portion of the tapered hole being greater than a circumference of a bottom portion thereof, by moving a hole cutting apparatus in a first direction facing a lower surface of the substrate from an exposed surface of the glass layer, the hole cutting apparatus including a cutting portion having a cross-sectional area in a horizontal direction that gradually decreases in a downward direction, and cutting a portion of the glass layer through rotation of the cutting portion, cutting at least a part of the adhesive layer by moving the hole cutting apparatus in the first direction through the rotation of the cutting portion, and moving the hole cutting apparatus in a second direction opposite to the first direction.

In an embodiment, the forming of the hole in the glass layer may include forming a hole in the glass layer by using the hole cutting apparatus, the hole cutting apparatus including the cutting portion having a thickness greater than a thickness of the glass layer.

In an embodiment, the cutting of the at least a part of the adhesive layer may include cutting at least a part of the adhesive layer when an upper surface of the cutting portion of the hole cutting apparatus is at a level higher than an upper surface of the glass layer.

In an embodiment, the moving of the hole cutting apparatus in the second direction may include moving the hole cutting apparatus in the second direction when a gap in a horizontal direction is formed between the side surface of the cutting portion and the hole of the glass layer.

In the hole cutting apparatus according to an embodiment, as a cutting portion has a cross-sectional area in the horizontal direction that decreases in a downward direction, generation of glass chips or debris and damage of a glass layer may be reduced.

Furthermore, in the hole cutting apparatus according to an embodiment, as the surface of the cutting portion has a reduced roughness, a hole having a smooth inner surface may be manufactured in the glass layer of the glass laminate substrate.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of a cross-section of a glass laminate substrate;

FIG. 2 is a schematic view of a hole cutting apparatus for cutting a hole in a glass laminate substrate according to a comparative example;

FIG. 3 illustrates an operation of forming a hole in a glass laminate substrate by using the hole cutting apparatus of FIG. 2;

FIG. 4 is a schematic view of a hole cutting apparatus for cutting a hole in a glass laminate substrate, according to an embodiment;

FIG. 5 illustrates an operation of forming a hole in a glass laminate substrate by using the hole cutting apparatus of FIG. 4;

FIG. 6 is a schematic view of a hole cutting apparatus for cutting a hole in a glass laminate substrate, according to an embodiment;

FIG. 7 illustrates an operation of forming a hole in a glass laminate substrate by using the hole cutting apparatus of FIG. 6;

FIG. 8 illustrates a manufacturing method used in conjunction with the hole cutting apparatus of FIG. 4;

FIG. 9 is a flowchart of a hole cutting method for cutting a hole in a glass laminate substrate, according to an embodiment; and

FIGS. 10 to 12 illustrate operations of a hole cutting method for cutting a hole in a glass laminate substrate, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments according to the concept of the disclosure will be described in detail with reference to the accompanying drawings. However, embodiments according to the concept of the disclosure may be modified in various other forms, and the scope of the concept of the disclosure should not be construed as being limited by the embodiments detailed below. Embodiments according to the concept of the disclosure should be interpreted as being provided to more fully explain the concept of the disclosure to those who have ordinary skill in the art. Like reference numerals denotes like constituent elements. Furthermore, various components and areas in the accompany drawings are schematically drawn. Accordingly, the concept of the disclosure is not limited by the relative size or spacing drawn on the attached drawing.

Terms such as “first” and “second” are used herein merely to describe a variety of constituent elements, but the constituent elements are not limited by the terms. Such terms are used only for the purpose of distinguishing one constituent element from another constituent element. For example, without departing from the right scope of the disclosure, a first constituent element may be referred to as a second constituent element, and vice versa.

Terms used in the specification are used for explaining a specific embodiment, not for limiting the disclosure. An expression used in a singular form in the specification also includes the expression in its plural form unless clearly specified otherwise in context. Terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain. Furthermore, the terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

In the accompanying drawings, variations from the shapes of the illustrations as a result, for example, of manufacturing techniques and/or tolerances, are to be expected. Accordingly, embodiments of the disclosure should not be construed as limited to the particular shapes of regions illustrated herein but are to include deviations in shapes that result, for example, from manufacturing. As used herein, the term “and/or” includes any and all combinations of one or more of the associated listed items.

Furthermore, the term “substrate” used herein may mean a substrate by itself, or a stack structure including a substrate and a certain layer or film formed on a surface thereof. Furthermore, the term “surface of a substrate” used herein may mean an exposed surface of a substrate by itself, or an external surface such as a certain layer or film formed on the substrate.

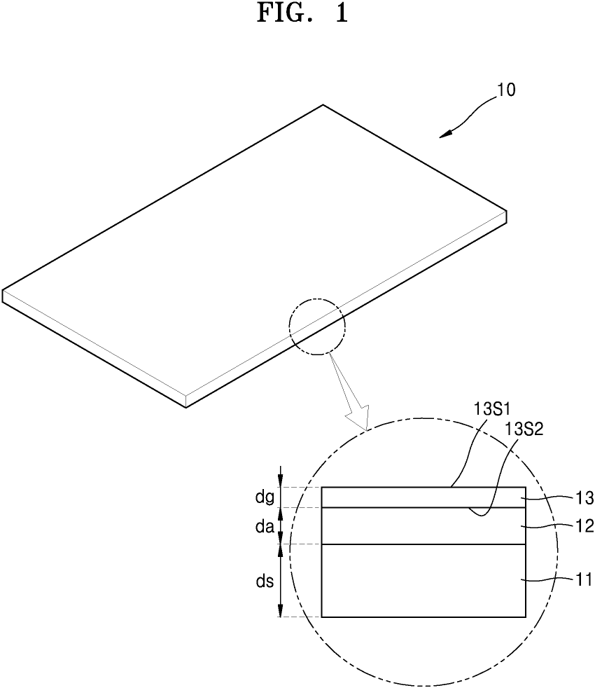

FIG. 1 is a schematic view of a cross-section of a glass laminate substrate 10.

Referring to FIG. 1, the glass laminate substrate 10 may include a substrate 11, a glass layer 13 laminated on the substrate 11, and an adhesive layer 12 to laminate the glass layer 13 on the substrate 11. For example, the glass laminate substrate 10 may be a substrate in which the substrate 11, the adhesive layer 12, and the glass layer 13 are sequentially stacked.

The substrate 11 may be formed of metal, wood, an inorganic material, an organic material, or a combination thereof, but the disclosure is not limited thereto. For example, the substrate 11 may include a high pressure laminate (HPL), paint-coated metal (PCM), a medium density fiberboard (MDF), vinyl-coated metal (VCM), or steel, but the disclosure is not limited thereto. In an embodiment, a thickness ds of the substrate 11 may be 500 micrometers or more.

The glass layer 13 may include, for example, borosilicate, aluminosilicate, boroaluminosilicate, alkali borosilicate, alkali aluminosilicate, alkali boroaluminosilicate, or soda lime, but the disclosure is not limited thereto.

A surface forming the top layer of the glass laminate substrate 10 among surfaces of the glass layer 13 may be defined to be a first surface 13S1. For example, the first surface 13S1 of the glass layer 13 may be an upper surface of the glass layer 13 that is exposed to the outside. Furthermore, among the surfaces of the glass layer 13, a surface contacting the adhesive layer 12 may be defined to be a second surface 13S2. For example, the second surface 13S2 of the glass layer 13 may be a lower surface of the glass layer 13 that is not exposed to the outside.

In an embodiment, a thickness dg of the glass layer 13 may be about 25 micrometers or more. For example, the thickness dg of the glass layer 13 may be about 25 micrometers to about 700 micrometers. Particularly, the thickness dg of the glass layer 13 may be about 100 micrometers to about 150 micrometers.

The adhesive layer 12 may be a layer that fixes and combines the substrate 11 and the glass layer 13. For example, the adhesive layer 12 may include a pressure sensitive adhesive (PSA), optically clear resin (OCR), or an optically clear adhesive (OCA), but the disclosure is not limited thereto.

In an embodiment, a thickness da of the adhesive layer 12 may be about 50 micrometers to about 300 micrometers. Particularly, the thickness da of the adhesive layer 12 may be about 75 micrometers to about 125 micrometers.

In an embodiment, the glass laminate substrate 10 may further include an image film layer (not shown) between the substrate 11 and the adhesive layer 12. The image film layer may be a film in which an image layer is printed on a polymer base. The polymer base may include, for example, a polypropylene (PP) film and a polyethylene terephthalate (PET) film, a polystyrene (PS) film, an acrylonitrile butadiene styrene (ABS) resin film, high density polyethylene (HDPE), low density polyethylene (LDPE), polyvinyl chloride (PVC), polyethylene naphthalate, polybutylene terephthalate, polycarbonate (PC), or a stacked film thereof.

The image layer may be a print layer on which an arbitrary content such as characters, pictures, symbols, and the like are printed. The image layer may be formed by, for example, inkjet printing or laser printing. The image layer may include a pigment component of ink for an inkjet printer or a pigment component of a toner for a laser printer.

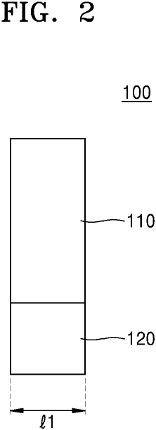

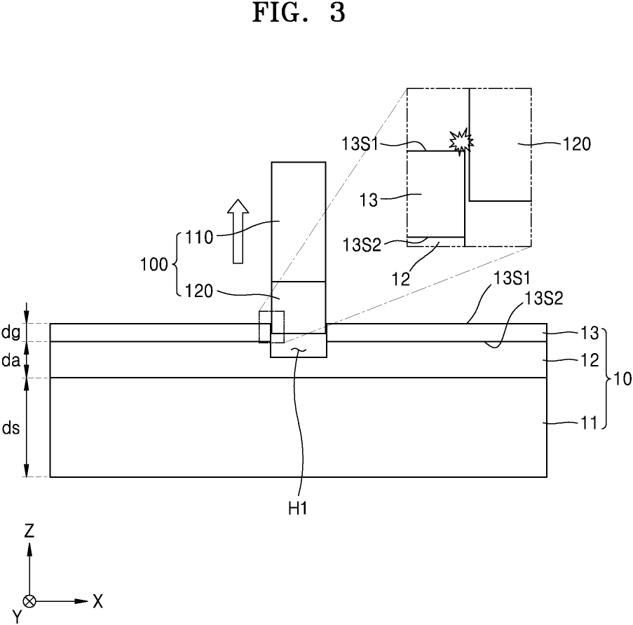

FIG. 2 is a schematic view of a hole cutting apparatus 100 for cutting a hole in the glass laminate substrate 10 according to a comparative example. The hole cutting apparatus 100 for cutting a hole in a glass laminate substrate illustrated in FIG. 2 may be an apparatus configured to cut a part of the glass laminate substrate 10 to form a hole (H1 of FIG. 3) in the glass layer 13 of the glass laminate substrate 10 of FIG. 1.

Furthermore, the hole cutting apparatus 100 may be configured to deburr a surface of the hole H1 formed in the glass layer 13. In detail, the hole cutting apparatus 100 may be configured to form the hole H1 by cutting a part of the glass layer 13 and simultaneously to remove debris and glass chips on the surface of the hole H1.

Referring to FIG. 2, the hole cutting apparatus 100 of the glass laminate substrate 10 may include a body 110 and a cutter 120 coupled to a lower portion of the body 110. The body 110 of the hole cutting apparatus 100 may be rotatable and configured to be combined with the cutter 120.

Furthermore, the cutter 120 of the hole cutting apparatus 100 may be coupled to the body 110 and configured to cut the glass laminate substrate 10 by rotation. For example, the cutter 120 may cut the glass layer 13 of the glass laminate substrate 10 to manufacture the hole H1 that penetrates the glass layer 13.

The cutter 120 may be a cylindrical shape. For example, when the hole cutting apparatus 100 is viewed from the side, the cutter 120 may have a rectangular shape. Furthermore, when the cutter 120 is viewed from a plan view, the cutter 120 may have a circular shape.

When the cutter 120 is viewed from a plan view, the width of the cutter 120 may be defined to be a diameter I1. Furthermore, when the cutter 120 is viewed from the side, the diameter I1 of the cutter 120 may be uniform in a vertical direction (Z direction). For example, the diameter I1 of an upper portion of the cutter 120 and the diameter I1 of a lower portion of the cutter 120 may be substantially the same.

FIG. 3 illustrates an operation of forming the hole H in the glass laminate substrate 10 by using the hole cutting apparatus 100 of FIG. 2.

Referring to FIG. 3, the hole cutting apparatus 100 is moved in a first direction (-Z direction) to cut the glass layer 13 and at least a part of the adhesive layer 12, thereby manufacturing the hole H1, and then retreated in a second direction (+Z direction) opposite to the first direction (-Z direction), thereby completing the manufacture of the hole H1.

The first direction (-Z direction) may be a direction from the first surface 13S1 of the glass layer 13 to the second surface 13S2. Furthermore, the first direction (-Z direction) may be a direction in which the hole cutting apparatus 100 is moved to cut the glass laminate substrate 10.

The second direction (+Z direction) may be a direction from the second surface 13S2 of the glass layer 13 to the first surface 13S1. Furthermore, the second direction (+Z direction) may be a direction in which the hole cutting apparatus 100 is moved to retreat after completing the cutting of the glass laminate substrate 10.

As the hole H1 of the glass layer 13 is manufactured by using the above-described cutter 120 of the hole cutting apparatus 100, the shape of the hole H1 of the glass layer 13 may be substantially the same as the shape of the cutter 120. For example, when the cutter 120 has a cylindrical shape, the hole H1 of the glass layer 13 that is cut and generated by the cutter 120 may also have a cylindrical shape.

The diameter of the cutter 120 and the diameter of the hole H1 generated by the glass layer 13 may be substantially the same. Furthermore, as the diameter I1 of the cutter 120 may be uniform in the vertical direction (Z direction), the diameter of the hole H1 of the glass layer 13 may also be uniform in the vertical direction (Z direction).

When the hole cutting apparatus 100 retreats in the second direction (+Z direction) after manufacturing the hole H1 in the glass laminate substrate 10, a gap in a horizontal direction may not be formed between a side surface of the cutter 120 and an inner side surface of the hole H1. Alternatively, the size of the gap in the horizontal direction between the side surface of the cutter 120 and the inner side surface of the hole H1 may be fine.

Accordingly, when the hole cutting apparatus 100 vibrates or tilts while moving in the second direction (+Z direction), friction occurs between the cutter 120 and the glass layer 13, and thus glass chips or debris is generated and the glass layer 13 may be damaged.

In the following description, a hole cutting apparatus and method of cutting a hole in the glass laminate substrate 10 according to an embodiment to solve the above-described problem are described in detail.

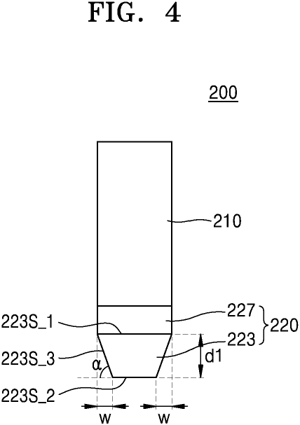

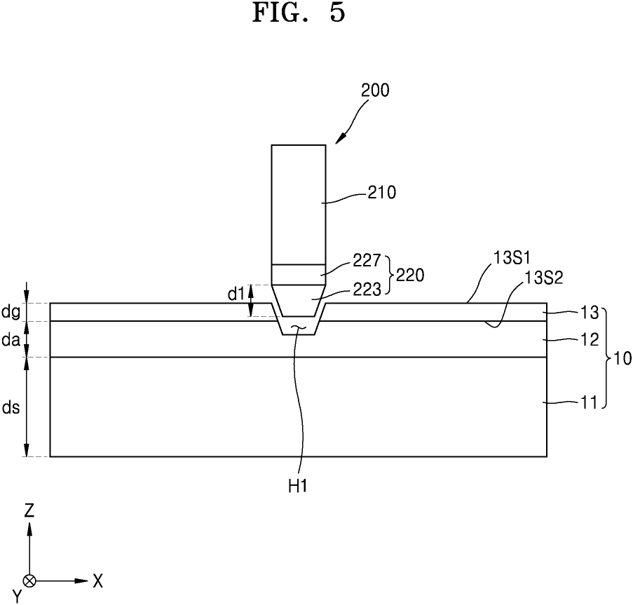

FIG. 4 is a schematic view of a hole cutting apparatus 200 for cutting a hole in the glass laminate substrate 10 according to an embodiment. The hole cutting apparatus 200 of the glass laminate substrate 10 of FIG. 4 may be an apparatus to cut a part of the glass laminate substrate 10 to form a hole H2 of FIG. 5 in the glass layer 13 of the glass laminate substrate 10 of FIG. 1.

The hole cutting apparatus 200 may include a body 210 configured to rotate about the Z axis and a cutter 220 coupled to the body 210 and cutting the glass laminate substrate 10.

The body 210 may have a cylindrical shape, and be configured to rotate about the Z axis. Furthermore, the lower portion of the body 210 may be coupled to the cutter 220. For example, the body 210 may include a metal material such as stainless steel.

The cutter 220 is coupled to the lower portion of the body 210 and may be configured to rotate based on the rotation of the body 210. The cutter 220 may manufacture a hole H2 by cutting a part of the glass laminate substrate 10 through rotation.

In an embodiment, the cutter 220 in a rotating state may be moved in the first direction (-Z direction) to cut the glass layer 13 and at least a part of the adhesive layer 12, thereby manufacturing a hole H2 of FIG. 5. Furthermore, the cutter 220 may retreat in the second direction (+Z direction) opposite to the first direction (-Z direction), thereby completing the manufacture of the hole H2.

In an embodiment, the cutter 220 may include a material having strength greater than the material of the glass layer 13. For example, the cutter 220 may include diamond.

The cutter 220 may include a cutting portion 223 and a connection portion 227. In an embodiment, the cutting portion 223 may be a portion of the cutter 220 that directly participates in the cutting of the glass laminate substrate 10. In other words, the cutting portion 223 of the cutter 220 may be a portion of the cutter 220 contacting the glass layer 13 and the adhesive layer 12 during the cutting of the glass laminate substrate 10.

In an embodiment, the cutting portion 223 may form the hole H1 in the glass layer 13 by cutting a part of the glass laminate substrate 10, and may be a portion of the cutter 220 that is configured to deburr the surface of the hole H1.

In an embodiment, the connection portion 227 may be a portion of the cutter 220 to connect the cutting portion 223 of the cutter 220 to the body 210 thereof. Furthermore, the connection portion 227 of the cutter 220 may be a portion of the cutter 220 that does not contact the glass layer 13 and the adhesive layer 12 during the cutting of the glass laminate substrate 10.

In an embodiment, the connection portion 227 may have a cylindrical shape. Furthermore, an axial surface of the connection portion 227 may be on the same plane as the side surface of the body 210. When the connection portion 227 is viewed from the side surface, the connection portion 227 may have a rectangular shape. Furthermore, when the connection portion 227 is viewed from a plan view, the connection portion 227 may have a circular shape. For example, a cross-section in the horizontal direction of the connection portion 227 may be uniform in the vertical direction.

In an embodiment, the cutting portion 223 may have a tapered shape with a cross-sectional area in the horizontal direction thereof decreasing in a downward direction. For example, the cross-section in the horizontal direction of the cutting portion 223 may be circular, and the diameter of the cutting portion 223 may decrease in a downward direction.

In an embodiment, the cutting portion 223 may include an upper surface 223S_1, a lower surface 223S_2 facing the upper surface 223S_1, and a side surface 223S_3 connecting the upper surface 223S_1 and the lower surface 223S_2 to each other.

In an embodiment, when the hole cutting apparatus 200 is viewed from the side, the side surface 223S_3 of the cutting portion 223 may be inclined downwardly as it approaches a center portion of the lower surface 223S_2. For example, when the hole cutting apparatus 200 is viewed from the side, the cutting portion 223 may have an inverted trapezoidal shape. Furthermore, the side surface 223S_3 of the cutting portion 223 may form an inclined angle α with the lower surface 223S_2.

In an embodiment, the thickness of the cutting portion 223, that is, a length d1 in the Z direction of the cutting portion 223, may be greater than the thickness of the glass layer 13, that is, a length dg in the Z direction of the glass layer 13. As the cutting portion 223 has a tapered shape such that a cross-sectional area in the horizontal direction decreases in a downward direction, and a thickness d1 of the cutting portion may be greater than the thickness dg of the glass layer 13, and the hole H2 of the glass layer 13 generated by using the cutting portion 223 may also have a tapered shape with a cross-sectional area in the horizontal direction decreasing in a downward direction.

Accordingly, after manufacturing the hole H2 of FIG. 5 in the glass laminate substrate 10 by using the hole cutting apparatus 200, when the hole cutting apparatus 200 is moved in the second direction (+Z direction), friction between the cutting portion 223 and the glass layer 13 may be prevented, glass chips or debris may not be generated, and damage to the glass layer 13 may be prevented.

In an embodiment, the thickness d1 of the cutting portion 223 may be greater than the thickness dg of the glass layer 13 and less than the thickness da of the adhesive layer 12. The disclosure is not limited thereto, and the thickness d1 of the cutting portion 223 may be greater than the sum of the thickness dg of the glass layer 13 and the thickness da of the adhesive layer 12.

For example, when the thickness da of the glass layer 13 is about 25 micrometers to about 700 micrometer, the thickness d1 of the cutting portion 223 may be greater than about 700 micrometers.

Furthermore, when the thickness of the glass layer 13 is about 100 micrometers to about 150 micrometers, the thickness d1 of the cutting portion 223 may be greater than about 150 micrometers.

In an embodiment, the radius of the cutting portion 223 may gradually decrease in a downward direction. For example, the radius of the upper surface 223S_1 of the cutting portion 223 may be less than the radius of the lower surface 223S_2.

The length of a difference between the radius of the upper surface 223S_1 of the cutting portion 223 and the radius of the lower surface 223S_2 may be defined as a protection length w. As the cutting portion 223 of the hole cutting apparatus 200 may have the protection length w, during the cutting of the glass laminate substrate 10 by using the hole cutting apparatus 200, the friction between the cutting portion 223 and the glass layer 13 may be prevented, glass chips or debris may not be generated, and damage to the glass layer 13 may be prevented.

In an embodiment, the protection length w generated due to the difference between the radius of the upper surface 223S_1 of the cutting portion 223 and the radius of the lower surface 223S_2 may be about 10 micrometers to about 500 micrometers.

When the protection length w is less than 10 micrometers, during the cutting of the glass laminate substrate 10 by using the hole cutting apparatus 200, due to vibration and tilt of the hole cutting apparatus 200, friction may be generated between the cutting portion 223 and the glass layer 13.

Furthermore, when the protection length w exceeds 500 micrometers, visibility of the tapered shape of the hole H2 generated by the cutting of the glass laminate substrate 10 using the hole cutting apparatus 200 may be increased. In other words, when the glass laminate substrate 10 is viewed from a plan view, the inner side surface of the hole H2 may be observed with the naked eye, the hole H2 may not be recognized as having a cylindrical shape.

In an embodiment, when the protection length w is about 10 micrometers to about 500 micrometers, during the cutting of the glass laminate substrate 10, in spite of the vibration and tilt of the hole cutting apparatus 200, no friction may be generated between the cutting portion 223 and the glass layer 13. Furthermore, when the glass laminate substrate 10 is viewed from a plan view, the inner side surface of the hole H2 may not be observed with the naked eye, the hole H2 may be recognized as having a cylindrical shape.

In an embodiment, the amount of the inclined angle α formed by the side surface 223S_3 and the lower surface 223S_2 of the cutting portion 223 may be defined as tan⁻¹ (the thickness d1 of the cutting portion 223 / the protection length w of the cutting portion 223).

In an embodiment, the amount of the inclined angle α may be about 15° to about 75°. In detail, the amount of the inclined angle α formed by the side surface 223S_3 and the lower surface 223S_2 of the cutting portion 223 may be about 15° to about 75°.

In an embodiment, when the amount of the inclined angle α exceeds 75°, during the cutting of the glass laminate substrate 10 using the cutting portion 223 of the hole cutting apparatus 200, friction may be generated between the cutting portion 223 and the glass layer 13 due to the vibration and tilt of the hole cutting apparatus 200. Accordingly, the glass layer 13 may be damaged by the cutting portion 223 of the hole cutting apparatus 200.

Furthermore, when the amount of the inclined angle α is less than 15°, the visibility of the tapered shape of the hole H2 generated by the cutting of the glass laminate substrate 10 using the cutting portion 223 of the hole cutting apparatus 200 may be increased. In other words, when the glass laminate substrate 10 is viewed from a plan view, the inner side surface of the hole H2 may be observed with the naked eye, and thus the hole H2 may not be recognized as having a cylindrical shape.

FIG. 5 illustrates an operation of forming the hole H2 in the glass laminate substrate 10 by using the hole cutting apparatus 200 of FIG. 4.

Referring to FIG. 5, the hole cutting apparatus 200 according to an embodiment may be moved in the first direction (-Z direction) to cut the glass layer 13 and at least a part of the adhesive layer 12, thereby manufacturing the hole H2, and then retreated in the second direction (+Z direction) opposite to the first direction (-Z direction), thereby completing the manufacture of the hole H2.

In an embodiment, as the hole H2 of the glass layer 13 may be generated by the cutter 220 of the hole cutting apparatus 200 described with reference to FIG. 4, the shape of the hole H2 of the glass layer 13 may be substantially the same as the shape of the cutting portion 223 of the cutter 220.

For example, when the cutting portion 223 has a tapered shape with a cross-sectional area in the horizontal direction decreasing in a downward direction, the hole H2 of the glass layer 13 that is cut and generated by the cutting portion 223 may also have a tapered shape with a cross-sectional area in the horizontal direction decreasing in a downward direction.

However, as described above, as the protection length w of the hole cutting apparatus 200 may be about 10 micrometers to about 500 micrometers, the hole H2 manufactured by the hole cutting apparatus 200, when observed with the naked eye, may be recognized as having a cylindrical shape.

In an embodiment, when the hole cutting apparatus 200 retreats in the second direction (+Z direction) after manufacturing the hole H2 in the glass laminate substrate 10, a gap in the horizontal direction may be formed between a side surface of the cutting portion 223 of the cutter 220 and an inner side surface of the hole H2.

Furthermore, when the hole cutting apparatus 200 is continuously moved in the second direction (+Z direction), the size of the gap in the horizontal direction formed between the side surface of the cutting portion 223 of the cutter 220 and the inner side surface of the hole H2 may be gradually increased. Accordingly, the friction between the cutting portion 223 and the glass layer 13 may be prevented, glass chips or debris may not be generated, and damage to the glass layer 13 may be prevented.

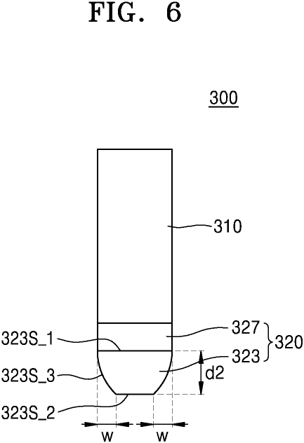

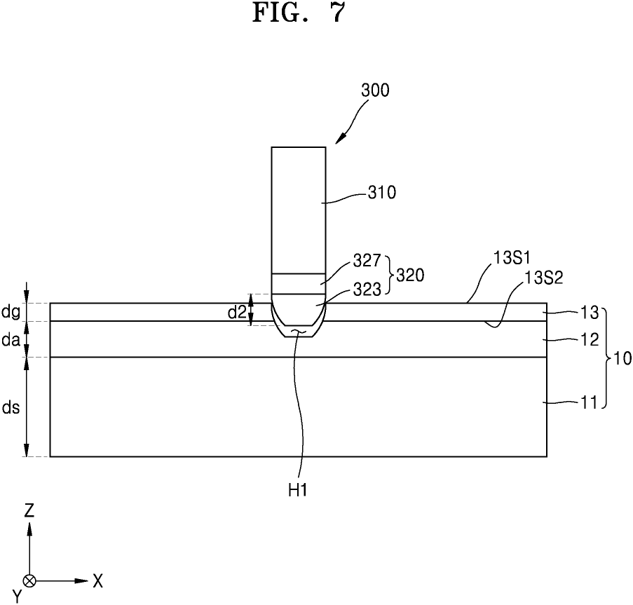

FIG. 6 is a schematic view of a hole cutting apparatus 300 for cutting a hole in the glass laminate substrate 10 according to an embodiment. The hole cutting apparatus 300 of the glass laminate substrate 10 of FIG. 6 may be an apparatus configured to cut a part of the glass laminate substrate 10 to manufacture a hole H3 of FIG. 7 in the glass layer 13 of the glass laminate substrate 10 of FIG. 1.

The hole cutting apparatus 300 may include a body 310 configured to rotate about the Z axis and a cutter 320 coupled to the body 310 to cut the glass laminate substrate 10. In the following description, redundant descriptions between the hole cutting apparatus 200 of FIG. 4 and the hole cutting apparatus 300 of FIG. 6 are omitted and only differences therebetween are mainly described.

In an embodiment, the cutter 320 may include a cutting portion 323 and a connection portion 327. Furthermore, the cutting portion 323 of the cutter 320 may have a cross-sectional area in the horizontal direction that decreases in a downward direction. For example, the cross-section in the horizontal direction of the cutting portion 323 may be circular, and the diameter of the cutting portion 323 may decrease in a downward direction.

In an embodiment, the cutting portion 323 may have an upper surface 323S_1, a lower surface 323S_2 facing the upper surface 323S_1, and a side surface 323S_3 connecting the upper surface 323S_1 and the lower surface 323S_2 to each other.

In an embodiment, when the hole cutting apparatus 300 is viewed from the side, the side surface 223S_3 of the cutting portion 223 may have a curved surface. In other words, the side surface 323S_3 of the cutting portion 323 of the hole cutting apparatus 300 may be rounded.

In an embodiment, when the side surface 323S_3 of the cutting portion 323 has a shape of a curved surface, the side surface 323S_3 of the cutting portion 323 may have an inclination that becomes gentle as it approaches the center portion of the lower surface 323S_2.

In an embodiment, when the hole cutting apparatus 300 is viewed from the side, the cutting portion 223 may be similar to a semi-circular shape.

In an embodiment, the thickness of the cutting portion 323, that is, the length d2 in the Z direction of the cutting portion 323, may be greater than the thickness of the glass layer 13, that is, the length dg in the Z direction of the glass layer 13.

As the cutting portion 323 has a shape with a cross-sectional area in the horizontal direction decreasing in a downward direction, and the thickness d2 of the cutting portion 323 is greater than the thickness dg of the glass layer 13, the hole H2 of the glass layer 13 generated by using the cutting portion 323 may also have a shape with a cross-sectional area in the horizontal direction decreasing in a downward direction.

Furthermore, after the hole H3 of FIG. 7 is manufactured in the glass laminate substrate 10 by using the hole cutting apparatus 300, when the hole cutting apparatus 300 is moved to retreat in the second direction (+Z direction), friction between the cutting portion 323 and the glass layer 13 may be prevented, glass chips or debris may not be generated, and damage to the glass layer 13 may be prevented.

In an embodiment, the thickness d2 of the cutting portion 323 may be greater than the thickness dg of the glass layer 13 and less than the thickness da of the adhesive layer 12. The disclosure is not limited thereto, the thickness d2 of the cutting portion 323 may be greater than the sum of the thickness dg of the glass layer 13 and the thickness da of the adhesive layer 12.

As described above, the length of the radius of the upper surface 323S_1 of the cutting portion 323 may be greater than the length of the radius of the lower surface 323S_2. Accordingly, the cutting portion 323 of the hole cutting apparatus 300 may have the protection length w. In an embodiment, the protection length w formed due to a difference between the radius of the upper surface 323S_1 of the cutting portion 323 and the radius of the lower surface 323S_2 may be about 10 micrometers to about 500 micrometers.

The protection length w of the hole cutting apparatus 300 may be about 10 micrometers to about 500 micrometers, and thus the hole H3 of FIG. 7 manufactured by the hole cutting apparatus 300, when observed with the naked eye, may be recognized as having a cylindrical shape.

Furthermore, as the hole cutting apparatus 300 may have the protection length w, during the cutting of the glass laminate substrate 10 using the hole cutting apparatus 300, friction between the cutting portion 323 and the glass layer 13 may be prevented, glass chips or debris may not be generated, and damage to the glass layer 13 may be prevented.

FIG. 7 illustrates an operation of forming the hole H3 in the glass laminate substrate 10 by using the hole cutting apparatus 300 of FIG. 6.

Referring to FIG. 7, the hole cutting apparatus 300 according to an embodiment is moved in the first direction (-Z direction) to cut the glass layer 13 and at least a part of the adhesive layer 12, thereby manufacturing the hole H3, and then retreated in the second direction (+Z direction) opposite to the first direction (-Z direction), thereby completing manufacture of the hole H3.

In an embodiment, as the hole H3 of the glass layer 13 may be generated by the cutter 320 of the hole cutting apparatus 300 described with reference to FIG. 6, the shape of the hole H3 of the glass layer 13 may be substantially the same as the shape of the cutting portion 323 of the cutter 320.

For example, when the cutting portion 323 has a semi-circular shape such that a cross-sectional area in the horizontal direction decreases in a downward direction, the hole H3 of the glass layer 13 that is cut and generated by the cutting portion 323 may also have a semi-circular shape with a cross-sectional area in the horizontal direction decreasing in a downward direction.

However, as the protection length w of the hole cutting apparatus 300 may be about 10 micrometers to about 500 micrometers, the hole H3 manufactured by the hole cutting apparatus 300, when observed with the naked eye, may be recognized as having a cylindrical shape.

In an embodiment, when the hole cutting apparatus 300 retreats in the second direction (+Z direction) after manufacturing the hole H3 in the glass laminate substrate 10, a gap in the horizontal direction may be formed between a side surface of the cutting portion 323 of the cutter 320 and an inner side surface of the hole H3.

Furthermore, when the hole cutting apparatus 300 continuously moves in the second direction (+Z direction), the size of the gap in the horizontal direction formed between the side surface of the cutting portion 323 of the cutter 320 and the inner side surface of the hole H2 may be gradually increased. Accordingly, friction between the cutting portion 323 and the glass layer 13 may be prevented, glass chips or debris may not be generated, and damage to the glass layer 13 may be prevented.

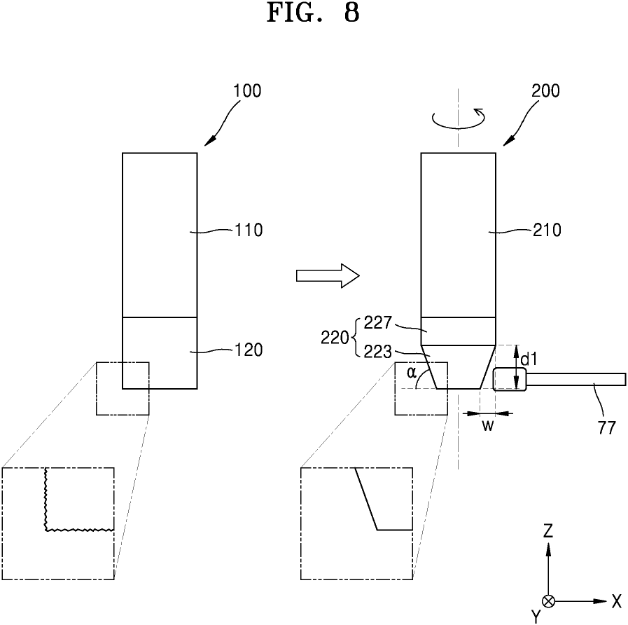

FIG. 8 illustrates a method of manufacturing the hole cutting apparatus 200 of FIG. 4.

Referring to FIG. 8, the hole cutting apparatus 100 of FIG. 1 may be prepared to manufacture the hole cutting apparatus 200 of FIG. 4. In the following description, the hole cutting apparatus 100 of FIG. 1 is referred to as the first hole cutting apparatus 100, and the hole cutting apparatus 200 of FIG. 4 is referred to as the second hole cutting apparatus 200.

In an embodiment, the second hole cutting apparatus 200 may be manufactured by grinding a part of the first hole cutting apparatus 100. The part of the first hole cutting apparatus 100 may be removed by a grinder 77. Accordingly, the second hole cutting apparatus 200 may have a tapered shape with a cross-sectional area in the horizontal direction decreasing in a downward direction.

In an embodiment, the cutting portion 223 of the cutter 220 of the second hole cutting apparatus 200 may be a part of the cutter 220 that is ground by the grinder 77. Furthermore, the connection portion 227 of the cutter 220 of the second hole cutting apparatus 200 may be a part of the cutter 220 that is not ground by the grinder 77.

In an embodiment, a lower portion of the cutter 120 of the first hole cutting apparatus 100 may be ground by the grinder 77. For example, while the first hole cutting apparatus 100 rotates about an axis in the Z direction, the lower portion of the cutter 120 of the first hole cutting apparatus 100 may be ground by the grinder 77.

Accordingly, the cutting portion 223 of the second hole cutting apparatus 200 may have a tapered shape with a cross-sectional area in the horizontal direction decreasing in a downward direction. For example, the cross-section in the horizontal direction of the cutting portion 223 may be circular, and the diameter of the cutting portion 223 may decrease in a downward direction.

When the surface of the cutter 120 of the first hole cutting apparatus 100 is enlarged, the surface of the cutter 120 may be rough. In detail, when the surface of the cutter 120 of the first hole cutting apparatus 100 is enlarged, the surface of the cutter 120 may be not even and may have a structure where a convex surface and a concave surface are repeated.

As a surface of the cutting portion 223 of the second hole cutting apparatus 200 may be ground by the grinder 77, roughness of the surface of the cutting portion 223 of the second hole cutting apparatus 200 may be less than roughness of the surface of the cutter 120 of the first hole cutting apparatus 200.

Furthermore, the roughness of the surface of the cutting portion 223 of the second hole cutting apparatus 200 may be less than the roughness of the surface of the connection portion 227 of the second hole cutting apparatus 200. In other words, although the connection portion 227 of the second hole cutting apparatus 200 is not ground by the grinder 77, as the cutting portion 223 may be ground by the grinder 77, the surface of the cutting portion 223 may be smoother than the surface of the connection portion 227.

Accordingly, the hole H2 of FIG. 5 formed by the second hole cutting apparatus 200 may have a uniform shape in the glass laminate substrate 10. For example, the inner surface of the hole H2 generated by the second hole cutting apparatus 200 may be smoother than inner surface of the hole H1 generated by the first hole cutting apparatus 100.

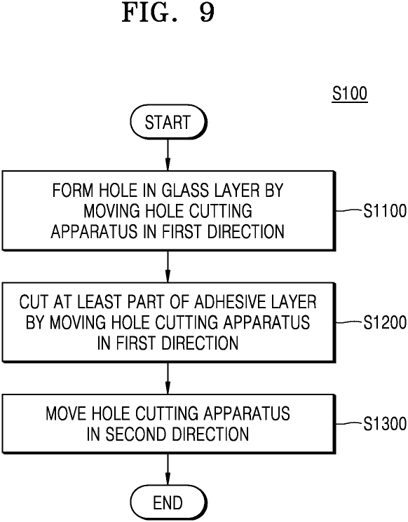

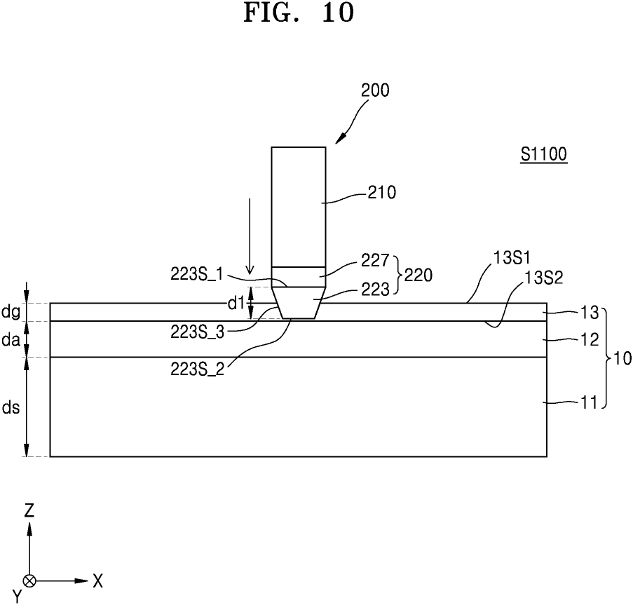

FIG. 9 is a flowchart of a hole cutting method S100 for cutting a hole in the glass laminate substrate 10 according to an embodiment. Furthermore, FIGS. 10 to 12 illustrate the respective operations of the hole cutting method S100 for cutting a hole in the glass laminate substrate 10 according to an embodiment.

The hole cutting method S100 of the glass laminate substrate 10 according to an embodiment may be a method of cutting a hole in the glass laminate substrate 10 including the substrate 11, the adhesive layer 12, and the glass layer 13 which are sequentially stacked.

Furthermore, the hole cutting method S100 of the glass laminate substrate 10 according to an embodiment may be a method of cutting the hole H2 of FIG. 5 in the glass laminate substrate 10 by using the hole cutting apparatus 200 described with reference to FIGS. 4 and 5. The disclosure is not limited thereto, and the hole cutting method S100 of the glass laminate substrate 10 may be a method of cutting the hole H3 of FIG. 7 in the glass laminate substrate 10 by using the hole cutting apparatus 300 described with reference to FIGS. 6 and 7.

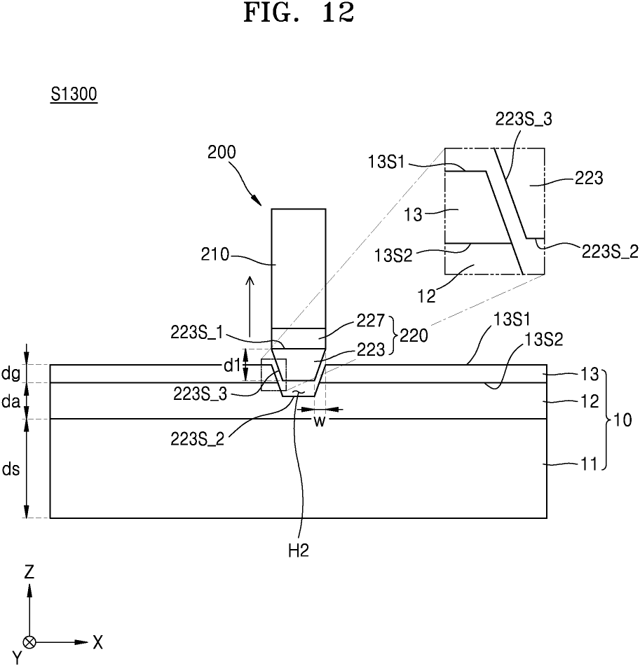

Referring to FIG. 9, the hole cutting method S100 of the glass laminate substrate 10 according to an embodiment may include forming the hole H2 of FIG. 12 in the glass layer 13 of the glass laminate substrate 10 by moving the hole cutting apparatus 200 in the first direction (-Z direction) (S1100), cutting at least a part of the adhesive layer 12 of the glass laminate substrate 10 by moving the hole cutting apparatus 200 in the first direction (-Z direction) (S1200), and moving the hole cutting apparatus 200 in the second direction (+Z direction) (S1300).

Referring to FIGS. 9 and 10 together, the hole cutting method S100 of the glass laminate substrate 10 may include forming the hole H2 in the glass layer 13 of the glass laminate substrate 10 by moving the hole cutting apparatus 200 in the first direction (-Z direction) (S1100).

In operation S1100, the hole H2 may be formed in the glass layer 13 of the glass laminate substrate 10 by moving the hole cutting apparatus 200 having the cutting portion 223 in the first direction (-Z direction), the cutting portion 223 having a tapered shape with a cross-sectional area in the horizontal direction decreasing in a downward direction.

In an embodiment, in operation S1100, a hole having a tapered shape may be formed in the glass layer 13 by moving the hole cutting apparatus 200 in the first direction (-Z direction) that is a direction from the first surface 13S1 that is an exposed surface of the glass layer 13 to a lower surface of the glass laminate substrate 10 and cutting a part of the glass layer 13 through the rotation of the cutting portion 223.

In an embodiment, the shape of the hole of the glass layer 13 generated by the cutting portion 223 of the hole cutting apparatus 200 may be a tapered shape with the circumference of the top portion of the hole being greater than the circumference of the bottom portion of the hole.

Furthermore, the shape of the hole of the glass layer 13 may be determined by the shape of the cutting portion 223 of the hole cutting apparatus 200. The circumference of the top portion of the hole of glass layer 13 may be less than or equal to the circumference of the upper surface 223S_1 of the cutting portion 223. Furthermore, the circumference of the bottom portion of the hole of the glass layer 13 may be greater than or equal to the circumference of the lower surface 223S_2 of the cutting portion 223.

In an embodiment, in operation S1100, the cutting portion 223 of the hole cutting apparatus 200 may directly participate in the cutting of the glass laminate substrate 10. For example, while rotating about the Z axis, the cutting portion 223 of the hole cutting apparatus 200 may pass through the first surface 13S1 of the glass layer 13.

In an embodiment, the cutting portion 223 of the hole cutting apparatus 200 used in operation S1100 may have a tapered shape with a cross-sectional area in the horizontal direction decreasing in a downward direction. For example, when the cutting portion 223 of the hole cutting apparatus 200 is viewed from the side surface, the cutting portion 223 may have a shape similar to an inverted trapezoidal shape or a semi-circular shape.

In an embodiment, the thickness d1 of the cutting portion 223 of the hole cutting apparatus 200 used in operation S1100 may be greater than the thickness dg of the glass layer 13. For example, the thickness d1 of the cutting portion 223 of the hole cutting apparatus 200 may be greater than the thickness dg of the glass layer 13 and less than the thickness da of the adhesive layer 12. The disclosure is not limited thereto, and the thickness d1 of the cutting portion 223 may be greater than the sum of the thickness dg of the glass layer 13 and the thickness da of the adhesive layer 12.

In an embodiment, the radius of the upper surface 223S_1 of the cutting portion 223 of the hole cutting apparatus 200 used in operation S1100 may be greater than the radius of the lower surface 223S_2. For example, the difference between the radius of the upper surface 223S_1 and the radius of the lower surface 223S_2 of the cutting portion 223 of the hole cutting apparatus 200 may be less than about 10 micrometers to about 500 micrometers.

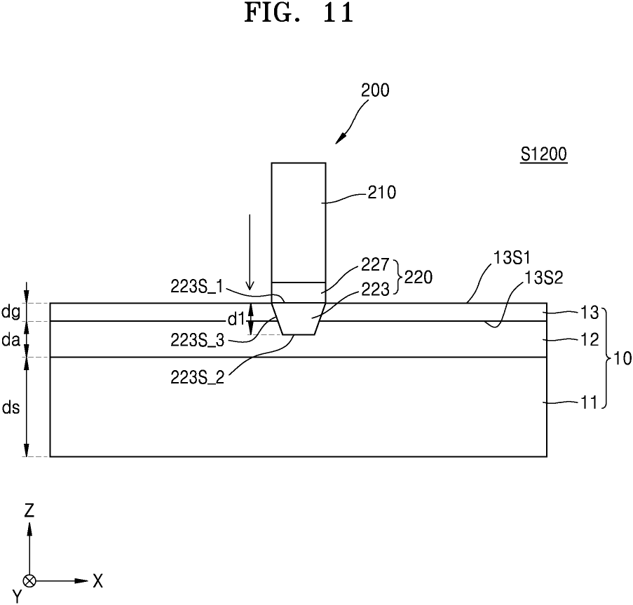

Referring to FIGS. 9 and 11 together, the hole cutting method S100 for cutting a hole in the glass laminate substrate 10 may include cutting at least a part of the adhesive layer 12 of the glass laminate substrate 10 by moving the hole cutting apparatus 200 in the first direction (-Z direction) (S1200).

In operation S1200, at least a part of the adhesive layer 12 of the glass laminate substrate 10 may be removed by moving the hole cutting apparatus 200 having the cutting portion 223 in the first direction (-Z direction), the cutting portion 223 having a tapered shape with a cross-sectional area in the horizontal direction decreasing in a downward direction.

In operation S1200, the hole cutting apparatus 200 may move in the first direction (-Z direction) to completely pass through the glass layer 13. In other words, the hole cutting apparatus 200 may pass through the first surface 13S1 and the second surface 13S2 of the glass layer 13.

In the operation in which the hole cutting apparatus 200 completely passes through the glass layer 13, at least a part of the adhesive layer 12 may be removed by the hole cutting apparatus 200. While the hole cutting apparatus 200 passes through the first surface 13S1 and the second surface 13S2 of the glass layer 13, the hole H2 that passes through the first surface 13S1 and the second surface 13S2 of the glass layer 13 may be formed.

In an embodiment, in operation S1200, the hole cutting apparatus 200 having the cutting portion 223 having a tapered shape with a cross-sectional area in the horizontal direction decreasing in a downward direction may be used.

In an embodiment, in operation S1200, the level of the upper surface 223S_1 of the cutting portion 223 of the hole cutting apparatus 200 may be higher than or equal to the level of the first surface 13S1 of the glass layer 13 of the glass laminate substrate 10. The level of the upper surface 223S_1 of the cutting portion 223 may be defined as a distance from the lower surface of the glass laminate substrate 10 to the upper surface 223S_1 of the cutting portion 223 in the vertical direction (Z direction)

In other words, in operation S1200, while the upper surface 223S_1 of the cutting portion 223 is located at a level higher than the first surface 13S1 of the glass layer 13, the hole cutting apparatus 200 may cut the glass layer 13 of the glass laminate substrate 10 and at least a part of the adhesive layer 12.

As described above, the roughness of the surface of the cutting portion 223 of the hole cutting apparatus 200 that participates in the cutting of the glass laminate substrate 10 may be less than the roughness of the surface of the connection portion 227 of the hole cutting apparatus 200 that does not participate in the cutting of the glass laminate substrate 10. Accordingly, in operation S1200, the inner surface of the hole H2 generated by the hole cutting apparatus 200 may be made smooth.

Referring to FIGS. 9 and 12 together, the hole cutting method S100 of the glass laminate substrate 10 may include moving the hole cutting apparatus 200 in the second direction (+Z direction) (S1300).

In operation S1300, the hole cutting apparatus 200 may move in the second direction (+Z direction) opposite to the first direction (-Z direction) to complete the manufacture of the hole H2 in the glass laminate substrate 10.

In an embodiment, in operation S1300, as the cutting portion 223 of the hole cutting apparatus 200 may have a tapered shape with a cross-sectional area in the horizontal direction decreasing in a downward direction, when the hole cutting apparatus 200 continuously moves in the second direction (+Z direction), the size of a gap in the horizontal direction between the side surface of the cutting portion 223 of the hole cutting apparatus 200 and the inner side surface of the hole H2 may gradually increase.

Accordingly, friction between the cutting portion 223 of the hole cutting apparatus 200 and the glass layer 13 may be prevented, glass chips or debris may not be generated, and damage to the glass layer 13 may be prevented.

It should be understood that the embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A hole cutting apparatus for forming a hole in a glass layer of a glass laminate substrate including a substrate, an adhesive layer, and the glass layer, which are sequentially stacked, the hole cutting apparatus comprising:
a rotatable body; and
a cutter coupled to a lower portion of the body, configured to form a hole in the glass layer by cutting the glass layer and at least a part of the adhesive layer and to deburr a surface of the hole, and comprising a cutting portion having a cross-sectional area in a horizontal direction that gradually decreases in a downward direction.

2. The hole cutting apparatus of claim 1, wherein, when viewed from a side thereof, the cutting portion has an inverted trapezoidal shape, and
a side surface of the cutting portion forms an inclined angle with a lower surface of the cutting portion, and the inclined angle is 15° to 75°.

3. The hole cutting apparatus of claim 1, wherein the side surface of the cutting portion is a curved surface having an inclination that decreases further toward a center portion of a lower surface of the cutting portion.

4. The hole cutting apparatus of claim 1, wherein a thickness of the cutting portion of the cutter is greater than a thickness of the glass layer.

5. The hole cutting apparatus of claim 4, wherein the thickness of the cutting portion of the cutter is greater than a sum of the thickness of the glass layer and a thickness of the adhesive layer.

6. The hole cutting apparatus of claim 4,
wherein, when the thickness of the glass layer of the glass laminate substrate is 100 micrometers to 150 micrometers, the thickness of the cutting portion of the cutter exceeds 150 micrometers.

7. The hole cutting apparatus of claim 1, wherein the section of the cutting portion of the cutter has a circular shape, and a radius of an upper surface of the cutting portion is greater than a radius of a lower surface of the cutting portion.

8. The hole cutting apparatus of claim 7, wherein a difference between the radius of the upper surface of the cutting portion and the radius of the lower surface of the cutting portion is 10 micrometers to 500 micrometers.

9. The hole cutting apparatus of claim 1, wherein the cutter comprises diamond.

10. A hole cutting apparatus for forming a hole in a glass layer of a glass laminate substrate including a substrate, an adhesive layer, and the glass layer, which are sequentially stacked, the hole cutting apparatus comprising:
a rotatable body; and
a cutter coupled to a lower portion of the body, configured to cut the glass layer and at least a part of the adhesive layer, and comprising a cutting portion having a cross-sectional area in a horizontal direction that gradually decreases in a downward direction and a connection portion connecting the cutting portion and the body.

11. The hole cutting apparatus of claim 10, wherein roughness of a surface of the cutting portion of the cutter is less than roughness of a surface of the connection portion of the cutter.

12. The hole cutting apparatus of claim 10 or claim 11, wherein, when viewed from a side thereof, the cutting portion has an inverted trapezoidal shape or a semicircular shape, and the connection portion has a rectangular shape.

13. The hole cutting apparatus of claim 10, wherein a thickness of the cutting portion is greater than a thickness of the glass layer.

14. The hole cutting apparatus of claim 10, wherein a section of the cutting portion of the cutter has a circular shape, and
a radius of an upper surface of the cutting portion is greater than a radius of a lower surface of the cutting portion, and a difference between the radius of the upper surface of the cutting portion and the radius of the lower surface of the cutting portion is 10 micrometers to 500 micrometers.

15. A hole cutting method of forming a hole in a glass layer of a glass laminate substrate including a substrate, an adhesive layer, and the glass layer, which are sequentially stacked, the hole cutting method comprising:
forming a tapered hole in the glass layer, a circumference of a top portion of the tapered hole being greater than a circumference of a bottom portion thereof, by moving a hole cutting apparatus in a first direction facing a lower surface of the substrate from an exposed surface of the glass layer, the hole cutting apparatus comprising a cutting portion having a cross-sectional area in a horizontal direction that gradually decreases in a downward direction, and cutting a portion of the glass layer through rotation of the cutting portion;
cutting at least a part of the adhesive layer by moving the hole cutting apparatus in the first direction through the rotation of the cutting portion; and
moving the hole cutting apparatus in a second direction opposite to the first direction.

16. The hole cutting method of claim 15, wherein the forming of the hole in the glass layer comprises forming a hole in the glass layer by using the hole cutting apparatus, the hole cutting apparatus comprising the cutting portion having a thickness greater than a thickness of the glass layer.

17. The hole cutting method of claim 15, wherein the cutting of the at least a part of the adhesive layer comprises cutting at least a part of the adhesive layer when an upper surface of the cutting portion of the hole cutting apparatus is at a level higher than an upper surface of the glass layer.

18. The hole cutting method of claim 15, wherein the moving of the hole cutting apparatus in the second direction comprises moving the hole cutting apparatus in the second direction when a gap in a horizontal direction is formed between the side surface of the cutting portion and the hole of the glass layer.
